(19) United States
(12) Patent Application Publication
(10) Pub. No.: US 2014/0114738 A1
(43) Pub. Date: Apr. 24, 2014

(54) Automatic Check-In Using Social-Networking Information

(71) Applicants: Erick Tseng, San Francisco, CA (US); Mohit Talwar, Redmond, WA (US); Adrian Potra, Redmond, WA (US); Michael John McKenzie Toksvig, Palo Alto, CA (US)

(72) Inventors: Erick Tseng, San Francisco, CA (US); Mohit Talwar, Redmond, WA (US); Adrian Potra, Redmond, WA (US); Michael John McKenzie Toksvig, Palo Alto, CA (US)

(21) Appl. No.: 13/659,743

(22) Filed: Oct. 24, 2012

(51) Int. Cl. H04L 29/08; G06Q 50/00

(52) U.S. Cl. CPC H04L 67/22; G06Q 50/01
USPC 705/14.27; 709/204; 705/26.8; 705/14.41

(57) ABSTRACT

In one embodiment, a method includes detecting by a computer system of an entity a client system identifier. The detection is accomplished using a first wireless communication method. The method further includes sending by the computer system the client system identifier to a social-networking system. The social-networking system includes multiple user profiles arranged in at least one social graph that stores relationships between the user profiles. The method also includes receiving at the computer system from the social-networking system user profile information from a user profile of the user profiles, the user profile identified by the social-networking system as being associated with the client system identifier. The method further includes sending information associated with the entity to the client system in response to receiving the user profile information.

### TECHNICAL FIELD

This disclosure generally relates to providing automatic check-in using social-networking information.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may transmit over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for determining its location, direction, or orientation, such as a GPS receiver, compass, or gyroscope. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

Particular embodiments of this disclosure are directed to providing automatic check-in using social-networking information. Check-in may include recording an indication of an individual's presence at a location. For example, a user with a smartphone walking into a store may be automatically checked in with the store through the smartphone using this method. In a particular embodiment, a computer system such as a check-in kiosk detects a client system identifier sent to the computer system using a wireless communication method. The client system may be a mobile computing device such as a smartphone. In one embodiment, the identifier of the client system may be a media access control (MAC) address. The computer system sends the identifier of the client system to a social-networking system. In one embodiment, a social-networking system may comprise a plurality of user profiles arranged in at least one social graph that stores relationships between the user profiles. In another embodiment, a social-networking system may be a computing system that includes user profiles stored in a database without relationships between the profiles. That is, in such an embodiment, the user profiles are not linked to the other user profiles. The social-networking system identifies a particular user profile that is associated with the identifier of the client system. For example, the user profile may specify that the client system corresponding to the client system identifier belongs to the user who created the user profile. The social-networking system the sends the computer system user profile information from the identified user profile. The user profile information may be any suitable information associated with the user profile. For example, the user profile information may include a confirmation that the client system identifier is associated with the user profile, a user name of the user profile, contact information, preferences indicated in the user profile, or any other suitable information associated with the user profile. In response to receiving the user profile information, information associated with the entity may be sent to the client system. This information is designed to customize the user's experience while visiting the entity and may include any suitable information, such as marketing information, a map of the entity, information about connections of the user and their interactions with the entity, or other suitable information.

Certain embodiments of the present disclosure may provide one or more technical advantages. A technical advantage of one embodiment includes providing automatic check-in with an entity for a user by wirelessly detecting an identifier of a client system used by the user. Another technical advantage of one embodiment includes provision of a customized user experience based on user profile information. Another technical advantage of one embodiment includes allowing a user to scan items for purchase and pay for the items using a client system rather than a point-of-sale terminal. Another technical advantage of one embodiment includes associating various customer loyalty accounts with a single user profile.

### BRIEF DESCRIPTION OF THE DRAWINGS

FIG. 1 illustrates an example network environment that provides automatic check-in using social-networking information.

FIG. 2 illustrates an example social graph.

FIG. 3 illustrates an example method for providing automatic check-in using social-networking information.

FIG. 4 illustrates an example computer system.

### DESCRIPTION OF EXAMPLE EMBODIMENTS

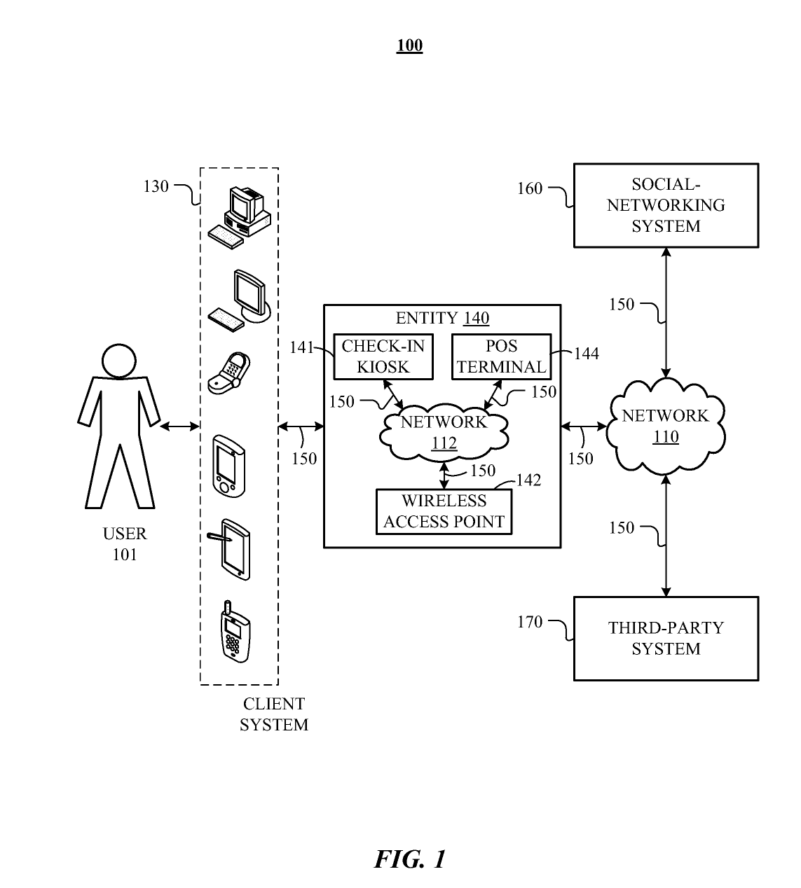

FIG. 1 illustrates an example network environment 100 that provides automatic check-in using social-networking information. Network environment 100 includes a user 101, a client system 130, an entity 140, a social-networking system 160, and a third-party system 170 connected to each other by a network 110. Although FIG. 1 illustrates a particular arrangement of user 101, client system 130, entity 140, social-networking system 160, third-party system 170, and network 110, this disclosure contemplates any suitable arrangement of user 101, client system 130, entity 140, social-networking system 160, third-party system 170, and network 110. As an example and not by way of limitation, two or more of client system 130, entity 140, social-networking system 160, and third-party system 170 may be connected to each other directly, bypassing network 110. As another example, two or more of client system 130, entity 140, social-networking system 160, and third-party system 170 may be physically or logically co-located with each other in whole or in part. Moreover, although FIG. 1 illustrates a particular number of users 101, client systems 130, entities 140, social-networking systems 160, third-party systems 170, and networks 110, this disclosure contemplates any suitable number of users 101, client systems 130, entities 140, social-networking systems 160, third-party systems 170, and networks 110. As an example and not by way of limitation, network environment 100 may include multiple users 101, client systems 130, entities 140, social-networking systems 160, third-party systems 170, or networks 110.

In the embodiment depicted, entity 140 includes check-in kiosk 141, wireless access point 142, and point-of-sale (POS) terminal 144 connected to each other by a network 112. Although FIG. 1 illustrates a particular arrangement of check-in kiosk 141, wireless access point 142, POS terminal 144, and network 112, this disclosure contemplates any suitable arrangement of check-in kiosk 141, wireless access point 142, POS terminal 144, and network 112. As an example and not by way of limitation, two or more of check-in kiosk 141, wireless access point 142, and POS terminal 144 may be connected to each other directly, bypassing network 112. As another example, two or more of check-in kiosk 141, wireless access point 142, POS terminal 144 may be physically or logically co-located with each other in whole or in part. Moreover, although FIG. 1 illustrates a particular number of check-in kiosks 141, wireless access points 142, POS terminals 144, and networks 112, this disclosure contemplates any suitable number of check-in kiosks 141, wireless access points 142, POS terminals 144, and networks 112. As an example and not by way of limitation, entity 140 may include multiple check-in kiosks 141, wireless access points 142, POS terminals 144, or networks 112.

In particular embodiments, user 101 may be an individual (human user), an entity (e.g., an enterprise, business, or third-party application), or a group (e.g., of individuals or entities) that interacts or communicates with or over other elements of network environment 100 such as devices coupled to network 110, entity 140 and any elements included therein, or social-networking system 160. In particular embodiments, one or more users 101 may use one or more client systems 130 to access, send data to, and receive data from network 110, elements of entity 140, social-networking system 160, or third-party system 170. Client system 130 may access network 110, elements of entity 140, social-networking system 160, or third-party system 170 directly or via a third-party system or device. As an example and not by way of limitation, client system 130 may access third-party system 170 via social-networking system 160. In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130.

In particular embodiments, client system 130 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser to a particular server (such as a server coupled to network 110, or a server associated with social-networking system 160 or third-party system 170), and the web browser may generate a Hyper Text Transfer Protocol (HTTP) request and communicate the HTTP request to the server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

This disclosure contemplates any suitable networks 110 and 112. As an example and not by way of limitation, one or more portions of network 110 or 112 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 or 112 may include one or more networks 110 or 112.

Links 150 may connect client system 130, entity 140 and its constituent elements, social-networking system 160, and third-party system 170 to communication network 110 or to each other. This disclosure contemplates any suitable links 150. In particular embodiments, one or more links 150 include one or more wireline (such as for example Ethernet, Digital Subscriber Line (DSL), or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, social-networking system 160 may be a network-addressable computing system hosting an online social network. Social-networking system 160 may generate, store, receive, and transmit social-networking data, such as, for example, user-profile data, concept-profile data, social-graph information, or other suitable data related to the online social network. Social-networking system 160 may be accessed by the other components of network environment 100 either directly or via network 110.

Social-networking system 160 may provide users of the online social network the ability to communicate and interact with other users. In particular embodiments, users may join the online social network via social-networking system 160 and then add connections (i.e., relationships) to a number of other users of social-networking system 160 whom they want to be connected to. Herein, the term “friend” may refer to any other user of social-networking system 160 with whom a user has formed a connection, association, or relationship via social-networking system 160.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160. In particular embodiments, social-networking system 160 may include an authorization server that allows users 101 to opt in or opt out of having their actions logged by social-networking system 160 or shared with other systems (e.g., third-party systems 170), such as, for example, by setting appropriate privacy settings.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from a client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include one or more user-profile stores for storing user profiles. A user profile may include, for example, a user name and password, identifiers of client systems 130 used by the user, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in or opt out of having their actions logged by social-networking system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users. Ad-pricing modules may combine social information, the current time, location information, or other suitable information to provide relevant advertisements, in the form of notifications, to a user.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet. Third-party system 170 may be accessed by the other components of network environment 100 either directly or via network 110.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

Entity 140 may represent any individual, business, or organization, including one or more associated locations. In the embodiment depicted, entity 140 includes check-in kiosk 141, wireless access point 142, and POS terminal 144 coupled by network 112. In particular embodiments, entity 140 may own or control check-in kiosk 141, wireless access point 142, and POS terminal 144. In particular embodiments, entity 140 is a business that offers products or services to customers. By way of example and not limitation, an entity 140 may be a grocery or department store, a bar, a fitness center, an amusement park, or a residence. Check-in kiosk 141, wireless access point 142, and POS terminal 144 may be located in or near the business. For example, check-in kiosk 141 may be located near an entry of the store to allow users 101 to check-in with entity 140 as they enter the store.

In particular embodiments, wireless access point 142 is operable to bridge or route data traffic between client system 130 and network 110. Wireless access point 142 may include a router, gateway, modem, a network switch, or other suitable device for providing network access to client systems 130. In particular embodiments, wireless access point 142 is capable of communicating with a plurality of client systems 130 via wired or wireless links 150. Wireless access point 142 is also capable of communicating with networks 110 and 112 via links 150.

In particular embodiments, POS terminal 144 is operable to scan one or more products provided by entity 140 and determine prices of the products. POS terminal 144 may also be operable to receive payment from user 101 for the products and print a receipt for the purchase. In particular embodiments, POS terminal 144 may include an integrated check-in kiosk 141 capable of detecting identifiers of client system 130 that POS terminal 144 interacts with. The identifiers may be used to match purchase information with user profiles of social-networking system 160 as explained in greater detail below.

In particular embodiments, check-in kiosk 141 includes a combination of hardware and/or software that may wirelessly communicate with client system 130 to facilitate check-in of a user 101 with entity 140. In particular embodiments, check-in kiosk 141 may be integrated with one or more other devices such as POS terminal 144, a fitness machine, a television, a digital video recorder (DVR), a photo booth, a thermostat, a computer, a radio, an automobile, or a security entrance. In particular embodiments, one or more check-in kiosks 141 may be placed near an entry to entity 140. In other embodiments, one or more check-in kiosks 141 may be placed at other suitable locations within or outside of a location associated with the entity having control over the check-in kiosk. During check-in, the check-in kiosk 141 may receive an identifier of the client system 130 and send the identifier to the social-networking system 160. The social-networking system 160 may determine a user profile that is associated with the identifier. The social-networking system 160 may send the check-in kiosk 141 or other computer system associated with entity 140 user profile information so that the entity may customize the user's experience. This process is explained in more detail below.

Check-in kiosk 141 may use any suitable communication method to determine identifiers of nearby client system 130. In particular embodiments, check-in kiosk 141 is operable to communicate with client system 130 using one or more wireless communication methods such as radio-frequency identification (RFID), near field communication (NFC), Wi-Fi (e.g., Institute of Electrical and Electronics Engineers (IEEE) 802.11 standard), Bluetooth, infrared (IR), audio signals, video signals (e.g., QR codes), or signals transmitted through the flash of a camera of client system 130. In particular embodiments, check-in kiosk 141 is capable of using multiple different communication methods to determine identifiers of client systems 130. In particular embodiments, check-in kiosk 141 may communicate with client systems 130 using multiple different wireless communication methods simultaneously. For example, check-in kiosk 141 may receive an RFID communication from a client system 130 relaying an identifier of the client system 130 while simultaneously receiving a Bluetooth communication from a different client system 130 relaying its own identifier.

In particular embodiments, multiple check-in kiosks 141 may be placed throughout a location, such as a store, airport, mall, or other area. Two or more of the check-in kiosks 141 may collectively operate to determine the location of client system 130. In particular embodiments, the check-in kiosks 141 may triangulate the position of client system 130 by measuring wireless signals received at the check-in kiosks 141 from client system 130, by receiving an indication of the strength of wireless signals sent to client system 130 by the check-in kiosks 141, or any other suitable method. In various embodiments, any of the wireless communication methods disclosed above may be utilized in determining the position of client system 130. Such embodiments may allow determination of where user 101 is within a particular location, such as a store, airport, mall, or other area and may facilitate provision of a map including the user's current location.

The check-in procedure performed by check-in kiosk 141 for a particular client system 130 may depend on whether the check-in is an initial check-in or a subsequent check-in. In the case of an initial check-in, the check-in may require conscious interaction by the user 101. For example, in particular embodiments, user 101 may be required to place the client system 130 near a portion of the check-in kiosk 141 to initiate the initial check-in so that a check-in is not inadvertently initiated when the user walks by check-in kiosk 141. In particular embodiments, the check-in kiosk 141 may include signage or a display that directs the user to swipe the client system 130 near the check-in kiosk in order to check in. As another example, user 101 may be required to interact with an input device (e.g., a touch screen or keyboard) of check-in kiosk 141 in order to proceed with an initial check-in.

During check-in of a client system 130, an identifier of the client system 130 may be sent from client system 130 to check-in kiosk 141 using any suitable wireless communication method, including any of those described above. Any suitable client system identifier may be used. For example, the identifier may include a MAC address of the client system, such as a Wi-Fi MAC address or a Bluetooth MAC address, an International Mobile Equipment Identity (IMEI) number, a serial number, or other suitable identifier.

In particular embodiments, the client system identifier may be sent by client system 130 to check-in kiosk 141 in response to a triggering event. In particular embodiments the triggering event may be an action performed by the user of client system 130. For example, the user action may involve the powering on of a machine, such as a piece of exercise equipment. Client system 130 may transmit the client system identifier in response to a detection that the machine has been powered on.

After obtaining the identifier of the client system 130, check-in kiosk 141 may associate the identifier with a user profile of user 101. The user profile may be a collection of information about user 101 stored by social-networking system 160 as described above. The association by the check-in kiosk 141 of the user profile with the client system identifier may be useful in cases where the social-networking system 160 does not yet store such an association in the user profile. Check-in kiosk 141 may obtain an identification of the user profile in any suitable manner and any suitable identification (e.g., user name of the user profile) may be used. For example, the identification may be sent from the client system 130 using the same wireless communication method used to send the identifier of the client system 130. As another example, the identification may be manually entered at the check-in kiosk 141 by the user 101 in response to a prompt provided during check-in (e.g., the prompt may be displayed by check-in kiosk 141 or by client system 130 in response to a message sent from check-in kiosk 141 to client system 130). In another embodiment, check-in kiosk 141 may receive the identifier of the client system 130 and send the identifier to social-networking system 160 to determine whether the identifier is already associated with a user profile. If the identifier is already associated with a user profile, check-in kiosk 141 may omit the request to the user 101 for identification of the user profile or may display an identification of the user profile and prompt user 101 to verify that the user profile is correct. Upon receiving the association between the identifier of the client system 130 and the user profile, the association may be stored by check-in kiosk 141 or other computer system associated with entity 140 or social-networking system 160 such that subsequent check-ins may access this information and process check-in requests based solely on the identifier of the client system 130.

During the initial check-in, the check-in kiosk 141 may ask the user 101 for permission to perform automatic check-ins. In order to entice the user 101 to accept the automatic check-in option (or to initially check in), check-in kiosk 141 may advertise benefits of checking in, such as free in-store Wi-Fi, discounts, or other benefits. Automatic check-ins may be accomplished with minimal effort by user 101. In particular embodiments, an automatic check-in may be accomplished without any user interaction during check-in. For example, as long as client system 130 is set to a mode that supports wireless communication with check-in kiosk 141, user 101 may be automatically checked in upon coming within range of check-in kiosk 141. As an example, an activated Wi-Fi or Bluetooth radio of client system 130 may establish a connection with check-in kiosk 141 as user 101 walks near check-in kiosk 141. Client system 130 may use this connection to transmit its identifier to check-in kiosk 141. As another example, client system 130 may broadcast the client identifier using any suitable wireless communication scheme and check-in kiosk 141 may detect the broadcast. Upon receiving the client system identifier, check-in kiosk 141 transmits the identifier to social-networking system 160 to effectuate check-in of the user 101.

In particular embodiments, different wireless communication methods may be used for the initial check-in and subsequent check-ins. For example, a short range communication method such as RFID or NFC may be used for the initial check-in so that check-in kiosk 141 does not initiate the initial check-in sequence unless the user consciously places the client system 130 near a particular portion of the check-in kiosk 141. A longer range communication method such as Wi-Fi or Bluetooth may be used for subsequent check-ins. The longer range communication method may be preferable for such check-ins because it may allow detection of the client system identifier as user 101 walks past check-in kiosk 141, even if the client system 130 is not extremely close to check-in kiosk 141 or if the line-of-sight between client system 130 and check-in kiosk is obstructed (e.g., client system 130 may be located in a pocket of user 101).

In particular embodiments, the user may provide the information used during the initial check-in (e.g., a MAC address or other identifier of the client system 130 and an identification of a user profile) through a computer system or website associated with entity 140 that is distinct from check-in kiosk 141. In particular embodiments, this information is stored in a database coupled to check-in kiosk 141. Thus, the information stored in the database may be utilized during a check-in attempt at one of the check-in kiosks 141 associated with the entity. Such embodiments may allow the user to check in through any of multiple check-in kiosks 141 associated with entity 140. In particular embodiments, the user may opt into automatic check-ins through the computer system or website associated with entity 140. Accordingly, in some situations, the first actual check-in by the user may be an automatic check-in.

Upon reception of the identifier of client system 130, information from the associated user profile is obtained by entity 140. In particular embodiments, check-in kiosk 141 sends the identifier and a request for user profile information to the social-networking system 160 and a computer system of entity 140 (which in some embodiments may be the check-in kiosk 141) receives and stores the user profile information. During subsequent check-ins of the user 101, entity 140 may access the locally stored user profile information or may again request user profile information from social-networking system 160.

In response to the check-in, various types of information or services may be provided to user 101 by any suitable components of entity 140 subject to the privacy permissions associated with the user profile. In a particular embodiment, free Wi-Fi or other wireless access may be provided to client system 130 by entity 140. For example, in response to the check-in, wireless access point 142 may complete a connection with client system 130 and provide client system 130 with wireless access to the Internet.

In particular embodiments, check-in may involve the addition of information associated with entity 140 to one or more user profiles stored by social-networking system 160. For example, a user profile of entity 140 may be modified to reflect the check-in by user 101. As another example, a user profile of the user 101 that checked in may be modified. For example, a profile page of user 101 may be updated with a message that indicates that the user checked in to entity 140, the location of entity 140, the time of the check-in, or other suitable information associated with the check-in. The modification of user profile information may be subject to the privacy settings associated with the user profile. If the user 101 allows location sharing, the location of the check-in may be shared with one or more other users of the social-networking system (e.g., the user's friends). Such, location sharing may be particularly useful in a location where the client system 130 may not have network access or precise location determination capabilities, such as a mall.

In particular embodiments, all or a portion of the user profile information received by entity 140 during check-in may be sent to a computer system used by an employee of entity 140 so that the employee may welcome user 101, inform the user about offers or other information user 101 may find relevant based on preferences, purchase history, or other user profile information, or perform other actions based on the user profile information. As an example, if entity 140 sells clothing, the user profile information sent to the employee may include clothing measurements of user 101 to facilitate the identification of proper clothing for the user or to aid the store during tailoring to clothing purchased by the user.

In various embodiments, equipment located within entity 140 may be customized based on the user profile information obtained during check-in. For example, a stereo system or television may display content based on the user profile information. As another example, settings of exercise equipment of a fitness center may be adjusted based on the user profile information. As yet another example, a digital billboard located within entity 140 may display customized marketing material information (e.g., advertisements, offers) based on the user profile information (e.g., as user 101 walks into entity 140). In particular embodiments, the equipment of entity 140 may be customized based on user profile information obtained from the checking in of multiple users 101. For example, a television in a bar may be tuned to a game featuring a team that has the most fans as indicated by the various sets of user profile information.

Upon check-in, entity 140 may instruct client system 130 to launch a website associated with entity 140 or a dedicated application. For example, the dedicated application may include a dedicated social media application or a dedicated application provided by 140. The website or dedicate application may provide functionality to enhance the user's experience at entity 140. Any suitable information or functions described below as being provided by the website or dedicated application may alternatively be provided or initiated via push notifications, text messages, or emails sent from entity 140 to client system 130 or through any other suitable means provided by entity 140.

The website or dedicated application may provide marketing information associated with entity 140 to user 101. For example, advertisements, offers, coupons, or other information may be provided to user 101 via client system 130. In particular embodiments, the marketing information is based on the user profile information accessed during check-in. For example, the marketing information may be based on the preferences of the user 101, past purchases of the user 101, recommendations from connections of the user 101 on social-networking system 160, or the like.

The website or dedicated application may provide a map of entity 140. For example if entity 140 is a department store, the map may show the various locations of departments within the store or the location of particular items. In particular embodiments, the map is searchable. For example, user 101 may enter the name of a particular item and the map may display the location of the item in text form or as an overlay on a visual depiction of entity 140. In particular embodiments, the real time location of the user 101 within the entity 140 is displayed on the map and updates as the user 101 changes location within the entity 140. In particular embodiments, the website or dedicated application may also include an option to page an employee of entity 140 for help locating an item or for other inquiries. In such embodiments, the location of user 101 within the entity 140 may be provided to the employee. In particular embodiments, the website or dedicated application may allow user 101 to reserve one or more resources associated with entity 140. For example, if entity 140 is an amusement park, the website or dedicated application may display a map of the park and an option to reserve a time to use one or more attractions at the park. The website or dedicated application might also notify user 101 when a reserved resource becomes available.

The website or dedicated application may provide information regarding other users that are connections of user 101. For example, an indication of the user's connections that have recently checked in to the same entity 140 may be provided. As another example, an indication of products or services available from entity 140 that have been purchased or recommended by connections of user 101 may be provided.

The website or dedicated application may also provide information regarding previous interactions between entity 140 and user 101 via client system 130 or other means. For example, if entity 140 is a fitness center, the website or dedicated application may display information associated with one or more previous workouts of user 101.

The website or dedicated application may provide an option to associate products or services with the user profile of user 101. For example, after a user 101 has checked in with entity 140, the user 101 may use client system 130 to scan a bar code or other identifier associated with a product or service provided by entity 140. The user 101 may also direct the website or dedicated application to post information about the product or service on a profile page of the user 101. Entity 140 may use the bar code or other identifier to look up relevant information associated with the product or service. This information may then be sent to social-networking system 160 for posting on the profile page. Any suitable information associated with the product or service may be posted, such as a photo, a description, a price, the name and location of entity 140, the number of products in stock, or other information. The user 101 may also include a message with the posting. For example, user 101 may post the product or service on the profile page in order to solicit advice from the user's connections as to whether the user should purchase the product or service. As another example, user 101 may post the product or service to inform others about a sale on the product or service. The post may include a link to the entity's website to facilitate purchase by a connection of the user 101 that views the post.

In particular embodiments, the website or dedicated application (or check-in kiosk 141) may provide an option for a user 101 to associate a customer loyalty account held with entity 140 to the user profile of the user. In general, a customer loyalty account may entitle a user 101 to discounts on certain products. Some customer loyalty accounts also provide cash back rewards or other benefits. A customer loyalty account generally includes a physical card associated with the account. When a customer checks out of a store, the customer presents the card (or a telephone number linked to the card) to the cashier. The card is scanned and discounts are applied. The purchases made by the customer may also be tracked and associated with the customer loyalty account. In particular embodiments, a user is able to associate a customer loyalty account to the user profile on social-networking system 160 and thus the user does not need to carry the physical card associated with the customer loyalty account. Instead, as long as the user profile is identifiable by entity 140 (e.g., by determining an association between the client system identifier and the user profile as described above), the customer loyalty account may be accessed and credited during checkout by user 101. The association between the customer loyalty account and the user profile may be stored by entity 140, social-networking system 160, or both. In particular embodiments, multiple customer loyalty accounts from different entities 140 may be associated with the user profile. Accordingly, any of these loyalty accounts may be used by identifying the user profile of the user. Since this may be accomplished through client system 130, the need to carry multiple loyalty cards is eliminated and the customer loyalty accounts may be consolidated with the user profile and accessed via client system 130.

The website or dedicated application may provide a self-checkout option that allows user 101 to checkout without waiting in line for checkout via a POS terminal 144. As the user 101 places a product in a physical shopping cart or basket, the user may also scan a bar code or other identifier of the product. In response to the scan, the product may be placed in a virtual shopping cart that is displayed by client system 130. The virtual shopping cart maintains a list of scanned products and relevant information about the products such as the prices and quantities of the products. When user 101 is finished shopping, the user may perform payment for the items in the virtual shopping cart via the website or dedicated application. Any suitable form of electronic payment may be used, such as a credit card transaction, a debit card transaction, or a transaction using virtual currency provided by social-networking system 160. During the payment phase, user profile information may be analyzed to determine whether user 101 has any coupons or discounts associated with his user profile that may be applied to the virtual shopping cart. For example, the user 101 may have previously received an offer from social-networking system 160 that is linked to the user profile. The website or dedicated application may also allow scanning and application of traditional coupons through client system 130 as well. In particular embodiments, when payment has been submitted, a receipt may be sent to an email account of the user 101 and to the entity 140 for security purposes.

In particular embodiments, a billing system of entity 140 is operable to associate purchases made by the user 101 with the user profile of the user. In particular embodiments, the purchase information may be stored by entity 140, social-networking system 160, or both. This information may be analyzed. Based on this analysis, entity 140 or social-networking system 160 may customize marketing information that is presented to user 101. For example, the marketing information may be based on previous purchases of the user 101.

The purchases may be associated with the user profile in any suitable manner. In particular embodiments, the association between the identifier of client system 130 and the user profile that is established during check-in may be utilized to properly associate purchases made by the user 101 to the user profile of the user. For example, in response to a check-in, entity 140 may maintain a connection (e.g., via Wi-Fi or Transmission Control Protocol (TCP)) with client system 130 through the duration of the user's visit. The user profile may be associated with this connection. If purchases are made from the client system 130, they may be mapped to the connection and the associated user profile. If purchases are made using POS terminal 144, the POS terminal may identify the user profile in another manner. For example, the POS terminal 144 may include an integrated check-in kiosk 141 that is operable to detect an identifier of client system 130 and determine the user profile associated with the identifier.

In embodiments where the purchase information is associated with the user profile and transmitted to social-networking system 160, social-networking system 160 may be able to track the efficiency of marketing information directed to user 101. For example, when user 101 browses profile pages or other websites provided by social-networking system 160, various advertisements may be included in these pages. Social-networking system 160 may be operable to store an indication of which advertisements were displayed to a particular user 101 and to correlate products in these advertisements with products purchased by user 101. Accordingly, social-networking system 160 may be operable to determine the efficacy of particular advertisements. In particular embodiments, social-networking system 160 may provide a report to entity 140 with statistics regarding advertisements shown to user 101 by social-networking system 160 and products purchased by user 101. For example, the report may detail the advertisements associated with the entity 140 that were shown to a particular user 101 or group of users. The advertisements associated with the entity 140 may be general advertisements for the entity 140 or advertisements for specific products or services provided by the entity 140. The report may also show instances that the specific products or services were purchased by user 101 or the group of users. In particular embodiments, the report may include a rate of conversion that describes how frequently a particular product was purchased from entity 140 when an advertisement for that product was directed to users by social-networking system 160.

In particular embodiments, social-networking system 160 receives check-in information from multiple entities 140. In such embodiments, social-networking system 160 may be capable of customizing marketing information directed to a user 101 based on the types of entities 140 that the user checks into. For example, if the user 101 frequently checks into bookstores and rarely checks into restaurants, then social-networking system 160 may direct more advertisements for books than restaurants to the user 101.

If check-in kiosk 141 is integrated with another device, the functionality of that device may be enhanced based on information obtained during the check-in. As an example, the device that is integrated with check-in kiosk 141 may configure itself based on information obtained from the user profile during check-in. For example, a fitness machine such as a treadmill may queue up a particular workout, a television or DVR may tune to a particular program or change settings, a photo booth may upload photos to the user profile or send the photos to client system 130, a thermostat may change settings, a computer may unlock or apply other settings, a radio may tune to a particular station, an automobile may unlock or apply other settings, or a security entrance may allow the user to enter a building or other location upon check-in by the user. In particular embodiments, the device may communicate any suitable information through the user profile to the client system 130. For example, the device may send a message to client system 130 asking whether the settings of the device should be changed.

In particular embodiments, user 101 may be checked in without using a client system 130 that is a computing device. In a particular embodiment, the user 101 may be checked in using biometric information associated with the user. For example, check-in kiosk 141 may perform facial recognition of the user or may scan a fingerprint of the user. Check-in kiosk 141 may determine a user profile associated with the biometric information or may send the biometric information to another computing system such as social-networking system 160 for a determination of the associated user profile. In other embodiments, check-in kiosk 141 may scan a sticker or card (e.g., that includes a barcode) carried by user 101 and use information obtained from the scan to identify the user profile of the user and check the user in. In particular embodiments, user 101 may be checked in (or his location identified) without using a check-in kiosk that is a computing device. For example, check-in kiosk 141 may be a sticker, card, or other object and check-in or location determination may be effectuated by scanning one or more check-in kiosks by client system 130 and using client system 130 to effectuate the check-in (e.g., by communicating with social-networking system 160 or a different device associated with entity 140) or determine the location. In particular embodiments, user 101 may be checked in without using a check-in kiosk 141. For example, a computing system associated with entity 140 may obtain the location (e.g., global positioning system (GPS) coordinates or other location identifiers) of client system 130 via network 110, network 112, or through other suitable means. In particular embodiments, client system 130 may compute its location periodically using a background process run by a processor of client system 130. The location of client system 130 may be received in conjunction with an identifier of client system 130 The computing system associated with entity 140 may determine whether the location of client system 130 coincides with a location associated with entity 140. Upon a positive determination, the computing system may effectuate check-in of the user (e.g., by sending a message to social-networking system 160).

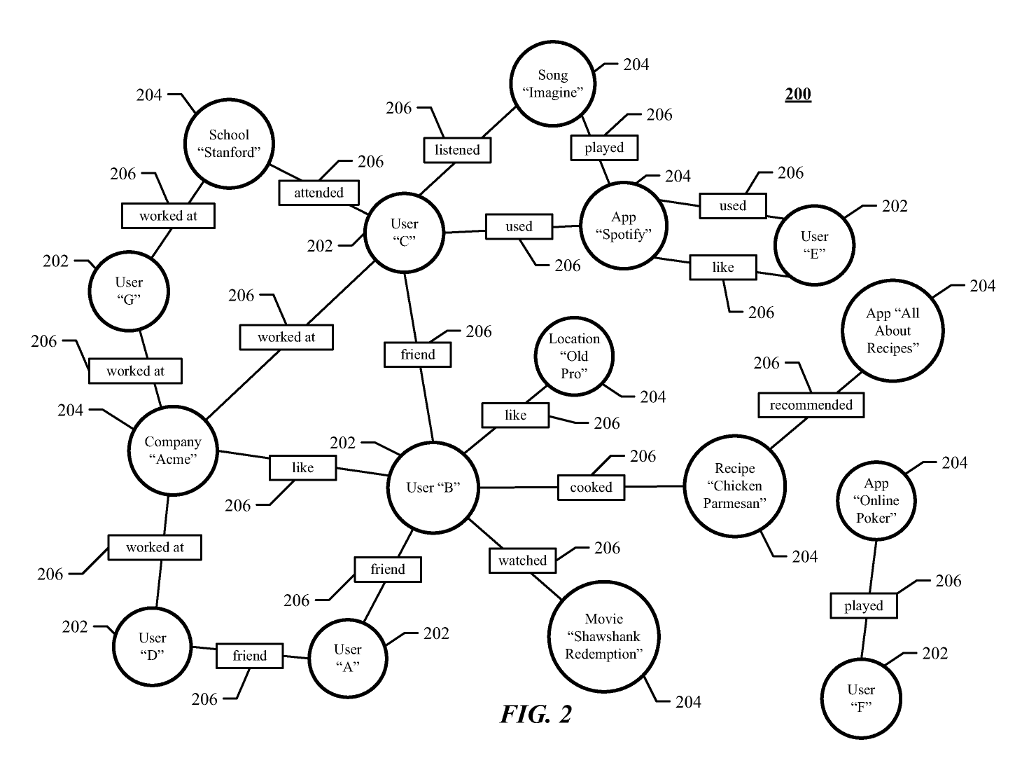

FIG. 2 illustrates an example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 130 to send to social-networking system 160 a message indicating the user's action. In response to the message, social-networking system 160 may create an edge (e.g., an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may transmit a “friend request” to the second user. If the second user confirms the “friend request,” social-networking system 160 may create an edge 206 connecting the first user's user node 202 to the second user's user node 202 in social graph 200 and store edge 206 as social-graph information in one or more data stores. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to transmit to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

In particular embodiments, a user profile stored by social-networking system 160 may include at least one user node 202 and an indication of the various concept nodes 204, edges 206, and other user nodes 202 associated with the particular user node 202.

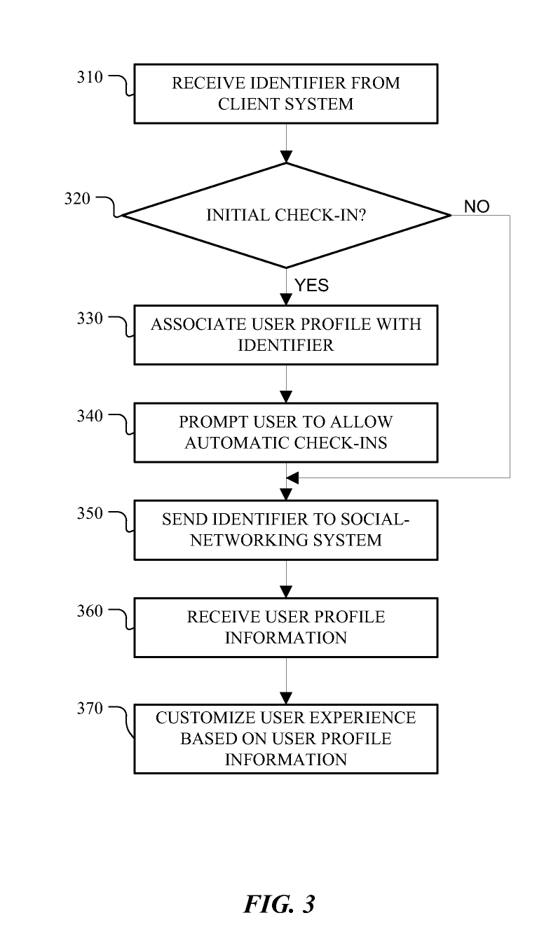

FIG. 3 illustrates an example method 300 for providing network access based on social-networking information. Method 300 may be performed by computer systems associated with entity 140. For example, all or a portion of method 300 may be performed by check-in kiosk 141. The method may begin at step 310, where an identifier is received from client system 130. The identifier may be received using any suitable communication method, such as a wireless communication method. At step 320 it is determined whether this is an initial check-in. If it is not, the method skips to step 350. If it is an initial check-in, the method moves to step 330 where a user profile is associated with the identifier of the client system 130. The user profile may be identified in any suitable manner, such as through a query to social-networking system 160 or user 101. At step 340, the user 101 is prompted to allow automatic check-ins in the future.

At step 350, the identifier received at step 310 is sent to social-networking system 160. The identifier may be accompanied by a request for user profile information from the user profile associated with the identifier. At step 360, user profile information is received. Any suitable computer system associated with entity 140 may receive the user profile information. In a particular embodiment, check-in kiosk 141 receives the user profile information.

At step 370, the user experience of user 101 is customized based on the received user profile information. For example, various information or services may be provided to the user 101 via client system 130 or devices associated with entity 140. By way of example and not limitation, such information and services may include free Wi-Fi, updating the user profile to reflect the check-in or activities performed while the user 101 is at entity 140, providing customized marketing information based on the user profile information, customizing equipment of the entity 140 based on the user profile information, providing a map of the entity 140, providing information regarding connections of the user 101 and their interactions with entity 140, associating a customer loyalty account with the user profile, and providing a self-checkout option via client system 130.

Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

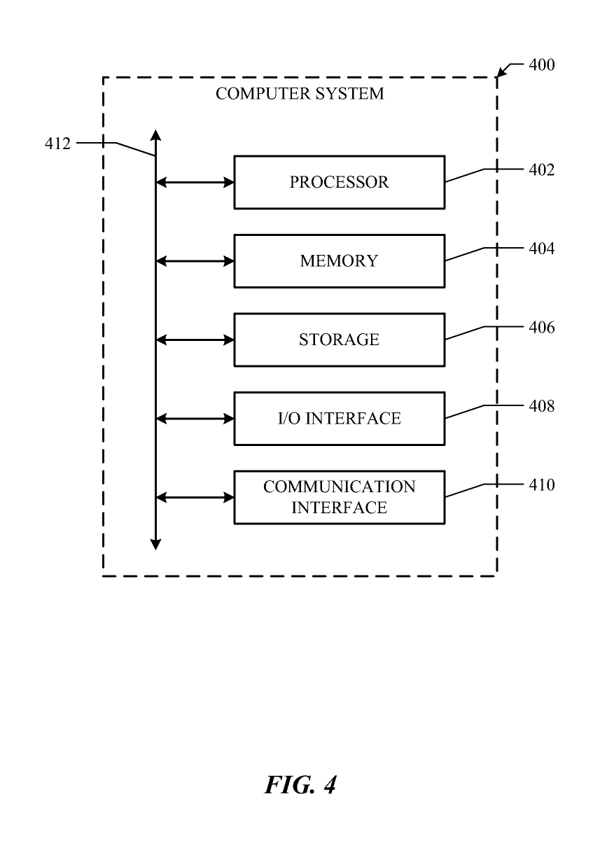

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. For example, client system 130, check-in kiosk 141, wireless access point 142, POS terminal 144, social-networking system 160, or third-party system 170 may include one or more portions of a computer system 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
detecting by a computer system of an entity a client system identifier, the detection accomplished using a first wireless communication method;
sending by the computer system the client system identifier to a social-networking system, the social-networking system comprising a plurality of user profiles arranged in at least one social graph that stores relationships between the user profiles;
receiving at the computer system from the social-networking system user profile information from a user profile of the plurality of user profiles, the user profile identified by the social-networking system as being associated with the client system identifier; and
in response to receiving the user profile information, sending information associated with the entity to the client system.

2. The method of claim 1, further comprising detecting the client system identifier by the computer system using a second wireless communication method prior to the detection of the client system identifier using the first wireless communication method, the second wireless communication method having a detection range shorter than a detection range of the first wireless communication method.

3. The method of claim 2, wherein the first wireless communication method is one of Wi-Fi or Bluetooth and the second wireless communication method is one of near field communication or radio-frequency identification.

4. The method of claim 1, wherein the information sent to the client system comprises marketing information associated with the entity that is based on the user profile information.

5. The method of claim 1, wherein the information sent to the client system comprises a map of the entity.

6. The method of claim 1, further comprising:
receiving a bar code scan of a product of the entity from the client system;
obtaining information describing the product based on the bar code scan; and
sending the information describing the product to the social-networking system with an instruction to publish the information on a user profile page corresponding to the identified user profile.

7. The method of claim 1, further comprising:
receiving a bar code scan of a product of the entity from the client system; and
storing the product in a virtual shopping cart associated with the identified user profile.

8. The method of claim 7, further comprising receiving payment from the client system for a plurality of products in the virtual shopping cart.

9. The method of claim 1, further comprising:
detecting a purchase of a product from the entity by a user of the client system;
sending a record of the purchase to the social-networking system; and
receiving an indication of whether an advertisement for the product had previously been directed to the user by the social-networking system.

10. The method of claim 1, further comprising:
identifying a customer loyalty rewards account associated with the identified user profile; and
crediting a purchase of one or more products of the entity to the customer loyalty rewards account.

11. A system comprising:
one or more processors; and
a memory coupled to the processors comprising instructions executable by the processors, the processors operable when executing the instructions to:
detect a client system identifier sent to an entity, the detection accomplished using a first wireless communication method;
send the client system identifier to a computing system comprising a plurality of user profiles;
receive from the computing system user profile information from a user profile of the plurality of user profiles, the user profile identified by the computing system as being associated with the client system identifier; and
in response to receiving the user profile information, send information associated with the entity to the client system.

12. The system of claim 11, wherein the processors are further operable when executing the instructions to detect the client system identifier using a second wireless communication method prior to the detection of the client system identifier using the first wireless communication method, the second wireless communication method having a detection range shorter than a detection range of the first wireless communication method.

13. The system of claim 11, wherein the user profiles of the computing system are arranged in at least one social graph that stores relationships between the user profiles.

14. The system of claim 11, wherein the processors are further operable when executing the instructions to:
receive a bar code scan of a product of the entity from the client system; and
store an indication of the product in a virtual shopping cart associated with the identified user profile.

15. The system of claim 11, wherein the processors are further operable when executing the instructions to
identify a customer loyalty rewards account associated with the identified user profile; and
credit a purchase of one or more products of the entity to the customer loyalty rewards account.

16. One or more non-transitory computer readable media comprising logic operable to:
detect a client system identifier sent to an entity, the detection accomplished using a first wireless communication method;
send the client system identifier to a computing system, the computing system comprising a plurality of user profiles;
receive from the computing system user profile information from a user profile of the plurality of user profiles, the user profile identified by the computing system as being associated with the client system identifier; and
in response to receiving the user profile information, send information associated with the entity to the client system.

17. The media of claim 16, wherein the logic is further operable to detect the client system identifier using a second wireless communication method prior to the detection of the client system identifier using the first wireless communication method, the second wireless communication method having a detection range shorter than a detection range of the first wireless communication method.

18. The media of claim 16, wherein the user profiles of the computing system are arranged in at least one social graph that stores relationships between the user profiles.

19. The media of claim 16, wherein the logic is further operable to:
receive a bar code scan of a product of the entity from the client system; and
store an indication of the product in a virtual shopping cart associated with the identified user profile.

20. The media of claim 16, wherein the logic is further operable to:
identify a customer loyalty rewards account associated with the identified user profile; and
credit a purchase of one or more products of the entity to the customer loyalty rewards account.
